(19) United States
(12) Patent Application Publication
(10) Pub. No.: US 2014/0080388 A1
(43) Pub. Date: Mar. 20, 2014

(54) MACHINE TOOL SWITCHING DEVICE

(71) Applicants: Manfred Lutz, Filderstadt (DE); Achim Trick, Sielmingen (DE); Thomas Schomisch, Filderstadt (DE); Florian Esenwein, Leinfelden-Echterdingen (DE)

(72) Inventors: Manfred Lutz, Filderstadt (DE); Achim Trick, Sielmingen (DE); Thomas Schomisch, Filderstadt (DE); Florian Esenwein, Leinfelden-Echterdingen (DE)

(73) Assignee: Robert Bosch GmbH, Stuttgart (DE)

(21) Appl. No.: 14/115,081

(22) PCT Filed: Mar. 15, 2012
(86) PCT No.: PCT/EP2012/054573

§ 371 Date: Oct. 31, 2013

(30) Foreign Application Priority Data
May 4, 2011 (DE) 10 2011 075 196.3

(51) Int. Cl. H01H 9/22; B24B 23/02

(52) U.S. Cl. CPC H01H 9/22; B24B 23/028
USPC 451/344; 200/43.16

(57) ABSTRACT

A machine tool switching device, in particular for portable machine tools, includes at least one switching unit that has at least one movably mounted operating element for actuating a mechanical, electrical, and/or electronic switching element. The machine tool switching device further includes at least one blocking device for blocking at least one movement of the operating element. The blocking device includes at least one movably mounted release element provided to lift the blockage of the operating element. The release element is mounted on the operating element so as to be movable in a translatory manner.

### PRIOR ART

Machine tool switching devices, in particular for portable machine tools which have a switching unit which has a movably mounted control element for actuating a mechanical, electric and/or electronic switching element and which include a blocking device for blocking a movement of the control element which has a movably mounted release element which is provided for the purpose of lifting the block of the control element, are already known.

### DISCLOSURE OF THE INVENTION

The invention proceeds from a machine tool switching device, in particular for portable machine tools, said machine tool switching device having at least one switching unit which has at least one movably mounted control element for actuating a mechanical, electric and/or electronic switching element, and having at least one blocking device for blocking at least one movement of the control element, said blocking device having at least one movably mounted release element which is provided for the purpose of lifting the block of the control element.

It is proposed that the release element is mounted so as to be movable in a translatory manner. The term “portable machine tool” is to be understood, in this case in particular, as a machine tool, in particular a manual machine tool which is able to be transported by an operator without a transporting machine. The weight of the portable machine tool is in particular less than 40 kg, in a preferred manner less than 20 kg and in a particular preferred manner less than 10 kg. The term “switching unit” is to define, in this case in particular, a unit which is provided for the purpose of modifying a state of a unit which is higher-ranking than the switching unit as a result of an actuation of at least the control element. In a particularly preferred manner, the switching unit is provided for the purpose of enabling and/or interrupting a power supply to a motor unit as a result of an actuation of the control element which acts on the switching element of the switching unit which is realized as a mechanical, electric and/or electronic switch and/or key. The switching element, which is realized as a mechanical, electric and/or electronic switch and/or key, is preferably arranged in a circuit between a power supply line, such as, for example a cable on which a plug is arranged for connection to a plug socket, and a consumer of the portable machine tool, such as, for example, a motor unit which is realized as an electric motor. In this context, the term “provided” is to define specially equipped and/or specially designed.

The term “mounted so as to be movable/movably mounted” is to define, in particular in this case, a bearing arrangement of an element, the element, in particular uncoupled from elastic deformation of the element, having a possibility of movement along at least one section greater than 1 mm, in a preferred manner greater than 5 mm and in a particularly preferred manner greater than 10 mm and/or a possibility of movement about at least one axis by an angle greater than 5°, in a preferred manner greater than 10° and in a particularly preferred manner greater than 20°. A “blocking device” is to be understood, in this case in particular, as a device which is provided for the purpose of preventing as extensively as possible, at least in one operating state, a movement of a movably mounted component along at least one section and/or about at least one axis by means of a mechanical, electric and/or electronic block. In a preferred manner the blocking device is provided for the purpose of preventing as extensively as possible, at least in one operating state of the blocking device, a movement of the movably mounted control element by means of a mechanical block. However, it is also conceivable for the blocking device to prevent a movement of the control element as extensively as possible at least in one operating state of the blocking device by means of introducing an electromagnetic force and/or introducing a permanent magnetic force, such as for example by means of displaceable magnets, onto the control element. By means of the development of the machine tool switching device as claimed in the invention, a blocking device which can be operated in a comfortable manner can be advantageously achieved. The blocking device can be advantageously arranged in a space-saving manner on the control element.

In addition, it is proposed that the release element is mounted on the control element so as to be movable in a translatory manner. However, it is also conceivable for the release element to be mounted so as to be movable in a translatory manner in a region of a housing of the portable machine tool directly adjoining the control element. By means of the arrangement of the release element on the control element, a comfortable operability of the release element can be achieved in an advantageous manner. By engaging the control element for example by means of one finger of a hand of the operator, an operator can actuate the release element in order consequently to lift a block on a movement of the control element.

In addition, it is proposed that the release element is arranged at least in part in a recess of the control element. A “recess” is to be understood, in particular in this case, as a region of the control element which, compared to adjacent regions, in particular compared to immediately adjoining regions, has a smaller material thickness, in particular a material thickness of 0 mm. In a particularly preferred manner, the edge regions defining the recess are provided for the purpose of guiding the release element. The release element, which is arranged in the recess, preferably extends at least by way of a part region of the release element along a direction which extends at least substantially at right angles to a control face of the control element over the control face of the control element. The term “substantially at right angles” is to define, in this case in particular, an alignment of a direction in relation to a reference direction, the direction and the reference direction, in particular when viewed in one plane, enclosing an angle of 90° and the angle having a maximum deviation of in particular less than 8°, in an advantageous manner less than 5° and in a particularly advantageous manner less than 2°. However, it is also conceivable for the release element, in an alternative development, to terminate at least substantially flush with the control face along the direction extending at right angles to the control face. A “control face” is to be understood, in this case in particular, as a face of the control element onto which an operator exerts a force for actuating the control element. The control face of the control element is preferably arranged on a side of the control elements which is remote from the mechanical, electric and/or electronic switching element. Through the partial arrangement of the release element in the recess of the control element, a sturdy arrangement of the release element can be achieved in an advantageous manner. If the portable machine tool which has the machine tool switching device were to fall, the release element can be supported in an advantageous manner on the control element and consequently can be protected from damage during the fall.

In an advantageous manner, the blocking device has at least one blocking element for blocking a movement of the control element in dependence on a position of the release element which is fixed on the release element. In a preferred manner, the blocking element is realized as a mechanical blocking element which is provided for the purpose of blocking a movement of the control element as a result of direct contact in a blocking position with a stop of the blocking device which is arranged in a housing of the portable machine tool. However, it is also conceivable for the blocking device to include a plurality of blocking elements which are provided for the purpose of blocking a movement of the control element by way of stops of the blocking device which are arranged in the housing of the portable machine tool. As a result, in an advantageous manner the control element can be prevented from bending or bending can be reduced as extensively as possible where an operator introduces a force onto the control element when the release element is not actuated. A number of stops which are arranged in the housing corresponds in a preferred manner to a number of blocking elements. In this connection, the blocking elements can be fixed on the release element, distributed uniformly and/or non-uniformly. In a particularly preferred manner, the blocking element is moved out of the blocking position and/or into the blocking position by means of a movement of the release element. A “blocking position” is to be understood, in this case in particular, as a position of the blocking element in which a movement of the control element is prevented as extensively as possible by means of the blocking element. In an advantageous manner, the blocking element is connected to the release element by means of a force-fitting, form-fitting and/or positively-bonding connection. In a particularly preferred manner, the blocking element is fixed on the release element by means of a latching connection. However, it is also conceivable for the blocking element to be fixed on the release element by means of a screw connection. The blocking element can preferably be moved in a translatory manner together with the release element. A space-saving development of the machine tool switching device as claimed in the invention can be achieved in an advantageous manner. As extensive as possible a block of a movement of the control element can be achieved in a structurally simple manner.

In an alternative development of the machine tool switching device as claimed in the invention, the blocking element is realized integrally with the release element. The term “integrally” is to be understood in particular as at least connected in a positively-bonded manner, for example by means of a welding process, an adhesive process, an injection process and/or another process which appears sensible to the expert, and/or to be understood, for example, as molded advantageously in one piece, such as for example by being produced from a casting and/or by being produced using a single or multiple component injection molding method and advantageously from one single blank. Additional components to form a connection between the blocking element and the release element can be advantageously dispensed with.

In addition, it is proposed that the blocking device has at least one spring element which is provided for the purpose of acting upon the release element with a spring force at least in one direction. A “spring element” is to be understood in particular as a macroscopic element which has at least one extension which is elastically modifiable in a normal operating state by at least 10%, in particular by at least 20%, preferably by at least 30% and in a particularly advantageous manner by at least 50%, and which generates in particular a counterforce which is dependent on a change in the extension and is preferably proportional to the change. An “extension” of an element is to be understood in particular as a maximum distance between two points of a perpendicular projection of the element onto a plane. A “macroscopic element” is to be understood in particular as an element with an extension of at least 1 mm, in particular of at least 5 mm and preferably of at least 10 mm. In a preferred manner, the spring element is provided for the purpose of acting upon the release element and/or the blocking element with a spring force in the direction of the blocking position. As a result, it can be advantageously achieved that the release element and/or the blocking element are moved into the blocking position once an introduction of force onto the control element as a result of the spring force has been lifted.

In an advantageous manner, the blocking device has at least one further release element which is arranged together with the release element on the control element so as to be movable in a translatory manner. The release element and the further release element, when viewed along a longitudinal direction of the control element, are arranged spaced apart in relation to one another. In a particularly preferred manner, the release element and the further release element are connected together by the blocking element. Comfortable actuation of the blocking device at different positions of the control element can be achieved in an advantageous manner.

In an alternative development of the machine tool switching device as claimed in the invention it is proposed that along a longitudinal direction of the control element the release element has an extension which is greater than 20% of an overall extension of the control element along the longitudinal direction. In a preferred manner, the release element extends along the longitudinal direction over more than 40% and in a particularly preferred manner over more than 60% of an overall extension of the control element. In this connection, on a side of the release element which is remote from the blocking element, in an advantageous manner the release element has a gripping structure, such as for example a ribbed surface structure, a surface with finger troughs and/or a different gripping structure which appears sensible to an expert. In an advantageous manner the release element is able to be controlled in a comfortable manner over a large region of the overall extension of the control element along the longitudinal direction.

In addition, it is proposed that the control element is rotatably mounted. In a particularly preferred manner, the control element is mounted so as to be rotatable about an axis of rotation which extends parallel to the longitudinal direction of the control element. The control element, in this connection, preferably includes bearing continuations, which are arranged in a mounted state of the control element in bearing recesses of a housing, in particular in a handle and/or handle region, of the portable machine tool. In this connection, the control element, preferably along the longitudinal direction of the control element, has an extension which is in particular greater than 40%, in a preferred manner greater than 60% and in a particularly preferred manner greater than 80% of an overall extension of a handle and/or of a handle region of the portable machine tool which extends along the longitudinal direction of the control element. A slight clamping tendency and comfortable actuation of the control element can be achieved in an advantageous manner.

In addition, the invention proceeds from a portable machine tool with at least one machine tool switching device as claimed in the invention. In a particularly preferred manner, the portable machine tool is realized as a right angle grinding tool. However, it is also conceivable for the portable machine tool to have a different development which appears sensible to a expert, such as for example as a manual planing tool, as a multi-functional machine tool, as a portable milling tool, as a grinding tool and/or as an electrically-operated garden instrument. A high level of operating comfort for an operator of the portable machine tool can be achieved in an advantageous manner.

The machine tool switching device as claimed in the invention is not be to be restricted in this connection to the above-described application and embodiment. In particular, for fulfilling a method of operation described herein, the machine tool switching device as claimed in the invention can have a number of individual elements, components units and apparatuses which deviates from a number named herein.

### DRAWING

Further advantages are produced from the following description of the drawing. Exemplary embodiments of the invention are shown in the drawing. The drawing, the description and the claims include numerous features in combination. The expert will also consider the features individually in an expedient manner and combine them to form sensible further combinations.

In which drawings:

FIG. 1 shows a schematic representation of a portable machine tool as claimed in the invention with a machine tool switching device as claimed in the invention,

FIG. 2 shows a schematic representation of a view of a detail of the machine tool switching device as claimed in the invention in a blocking position,

FIG. 3 shows a schematic representation of a view of a detail of the machine tool switching device as claimed in the invention in a release position,

FIG. 4 shows a schematic representation of a view of a detail of an arrangement of the machine tool switching device as claimed in the invention,

FIG. 5 shows a schematic representation of a view of a detail of a connection between a release element and a blocking element of the machine tool switching device as claimed in the invention,

FIG. 6 shows a schematic representation of a view of a detail of an alternative connection between a release element and a blocking element of the machine tool switching device as claimed in the invention,

FIG. 7 shows a schematic representation of a view of a detail of an alternative machine tool switching device as claimed in the invention in a blocking position,

FIG. 8 shows a schematic representation of a view of a detail of a further alternative machine tool switching device as claimed in the invention in a blocking position,

FIG. 9 shows a schematic representation of a view of a detail of a further alternative machine tool switching device as claimed in the invention in a blocking position and

FIG. 10 shows a schematic representation of a view of a detail of a further alternative machine tool switching device as claimed in the invention in a blocking position.

### DESCRIPTION OF THE EXEMPLARY EMBODIMENTS

FIG. 1 describes a portable machine tool 12a which is realized as a right angle grinding tool 36a with a machine tool switching device 10a. The right angle grinding tool 36a has a machine tool housing 38a which includes a gear housing 42a and a motor housing 44a. In addition, the right angle grinding tool 36a has a main handle 40a which is formed by the motor housing 4a. The main handle 40a extends proceeding from the gear housing 42a in a direction which is remote from the gear housing 42a and extends at least substantially parallel to a main extension direction 48a of the right angle grinding tool 36a. In this connection, the main handle 40a has a development which is at least substantially cylindrical. However, it is also conceivable for the main handle 40a to have a different development which appears sensible, in particular ergonomically sensible, to an expert. The motor housing 44a is provided for receiving a drive unit 50a of the right angle grinding tool 36a. The gear housing 42a is provided for receiving a driven unit 52a of the right angle grinding tool 36a, which includes a drive spindle 46a for a rotating drive of a processing tool (not shown in any detail here). An auxiliary handle fastening device 54a is fastened on the gear housing 42a. The auxiliary handle fastening device 54a has a plurality of auxiliary handle receiving elements 56a (only one auxiliary handle receiving element 56a can be seen in FIG. 1) which are arranged distributed uniformly along a circumferential direction on the gear housing 42a. The auxiliary handle receiving elements 56a are provided for the purpose of receiving a fastening region of a removable auxiliary handle (not shown here in any detail). The fastening region of the auxiliary handle can be screwed into the auxiliary handle receiving elements 56a for example by means of a screw connection for fixing the auxiliary handle on the gear housing 42a. The auxiliary handle extends transversely with respect to the main extension direction 48a of the right angle grinding tool 36a with the fastening region of the auxiliary handle mounted in an auxiliary handle receiving element 56a.

The machine tool switching device 10a includes a switching unit 14a which has a movably mounted control element 16a for actuating a mechanical, electric and/or electronic switching element 18a of the switching unit 14a. The control element 16a is arranged on the main handle 40a on a side of the main handle 40a facing the drive spindle 46a. As an alternative to this, the control element 16a could also be arranged on a side of the main handle 40a which is remote from the drive spindle 46a or on a different side which appears sensible to an expert. In particular, the main handle 40a could be rotatable in relation to the gear housing 42a. The control element 16a extends along a longitudinal direction 34a of the control element 16a which extends at least substantially parallel to the main extension direction 48 of the right angle grinding tool 36a, on the main handle 40a or on the motor housing 44a. In this case, an overall extension of the control element 16a along the longitudinal direction 34a corresponds to approximately 80% of an overall extension of the main handle 40a along a longitudinal direction 34a. The control element 16a has a control face 62a with an at least substantially rectangular projection face. The control face 62a is realized curved in a direction remote from the main handle 40a. A sealing element 134a of the right angle grinding tool 36a is arranged between the control element 16a and the main handle 40a, as a result of which an interior, which is surrounded by the main handle 40a or by the motor housing 44a is protected from ingress of dirt and/or of dust. The sealing element 134a is arranged in a groove in the main handle 40a or in the motor housing 44a facing the control element 16a. The switching element 18a is arranged in the interior which is surrounded by the main handle 40a or by the motor housing 44a. In this connection, the switching element 18a is arranged in a region of the interior which is arranged on a side of the main handle 40a or of the motor housing 44a which is remote from the gear housing 42a.

The control element 16a is mounted on the main handle 40a or on the motor housing 44a so as to be movable. In this connection, the control element 16a is mounted on the main handle 40a or on the motor housing 44a so as to be pivotable. The control element 16a has two bearing bolts 64a, 66a (FIG. 4) which are provided for the purpose of mounting the control element 16a so as to be pivotable about an axis 68a, which is aligned parallel to the main extension direction 48a of the right angle grinding tool 36a, in relation to the main handle 40a or to the motor housing 44a. The bearing bolts 64a, 66a are integrally molded onto the control element 16a. However, it is also conceivable for the bearing bolts 64a, 66a to be fixed on the control element 16a by means of a form-fitting and/or force-fitting connection. The main handle 40a or the motor housing 44a includes two bearing receiving means 70a, 72a in which the bearing bolts 64a, 66a are arranged in a mounted state of the control element 16a. The control element 16a is pivotable in part into the interior, which is surrounded by the main handle 40a or by the motor housing 44a, as a result of an interaction between the bearing bolts 64a, 66a and the bearing receiving means 70a, 72a. The switching unit 10a includes a spring element (not shown in any detail) which brings about a force onto the control element 14a in order, once an introduction of force from an operator onto the control element 16a is lifted, to pivot the control element 16a out of the interior into a starting position in which the switching element 18a of the control element 16a is not actuated. The control element 16a has a stop (not shown here in any detail) which, in a non-actuated state of the control element 16a, abuts against an inner wall of the main handle 40a or of the motor housing 44a which defines the interior which is surrounded by the main handle 40a or by the motor housing 44a. The stop prevents the control element 16a completely pivoting out of the interior, which is surrounded by the main handle 40a or by the motor housing 44a, as a result of a spring force of the spring element (not shown in any detail).

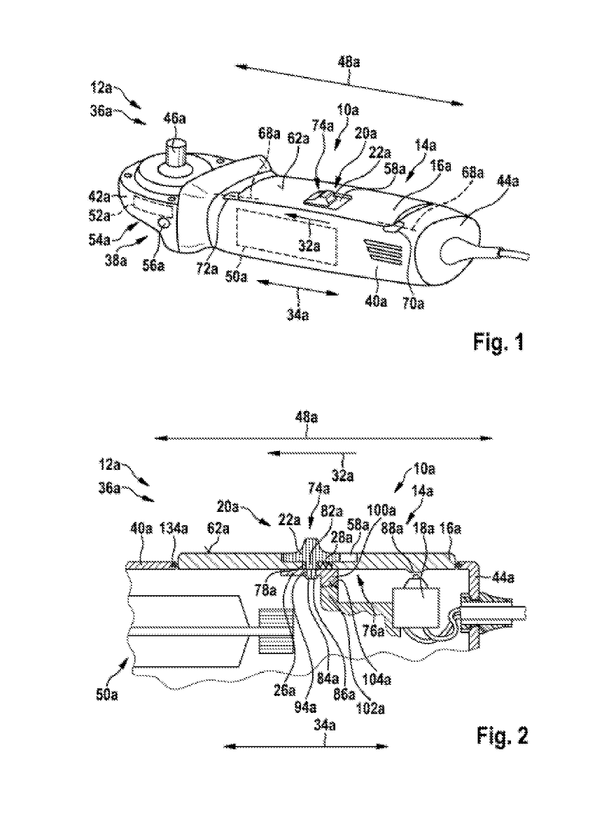

The control element 16a also has an actuating continuation 88a (FIG. 2) for actuating the mechanical, electric and/or electronic switching element 18a of the switching unit 14a. The actuating continuation 88a is provided for the purpose of actuating the switching element 18a as a result of a pivoting movement of the control element 16a. The actuating continuation 88a extends proceeding from the control element 16a into the interior which is surrounded by the main handle 40a or by the motor housing 44a. In addition, the actuating continuation 88a, in a mounted state of the control element 16a, is arranged on the control element 16a on a side of the control element 16a which is remote from the gear housing 42a. The switching element 18a, in this connection, is realized as an electric pressure switch.

In addition, the machine tool switching device 10a includes a blocking device 20a for blocking at least one movement of the control element 16a, which has a movably mounted release element 22a which is provided for the purpose of lifting the block of the control element 16a. The release element 22a is mounted so as to be movable in a translatory manner. In this connection, the release element 22a is mounted on the control element 16a so as to be movable in a translatory manner. Consequently, the release element 22a is realized as a slide switch. The release element 22a is arranged in part in a recess 58a of the control element 16a. Edge regions which define the recess 58a are in each case at the same distance to an edge of the control element 16a along the main extension direction 48a. Consequently, the recess 58a is arranged centrally and/or the release element 22a is arranged centrally in the control element 16a at least in one operating position.

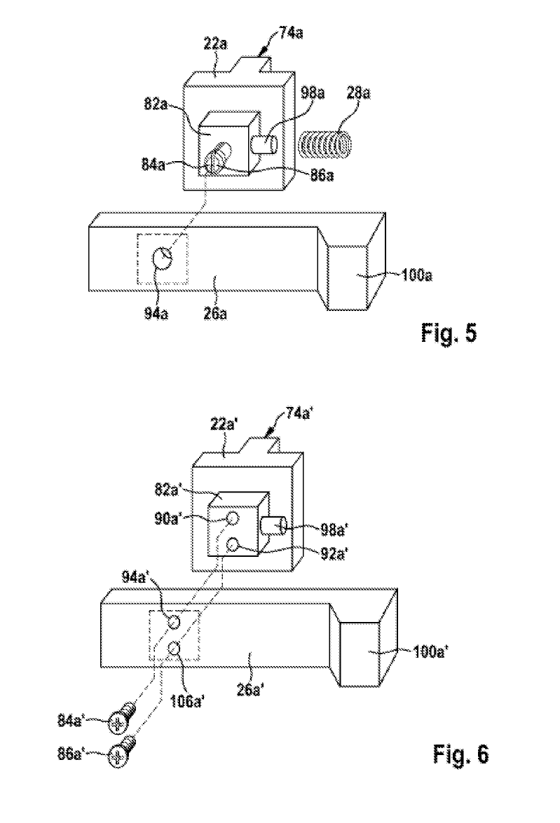

FIG. 2 shows an arrangement of the release element 22a in the recess 58a of the control element 16a. An actuating region 74a of the release element 22a extends along a direction which extends at least substantially at right angles to the control face 62a of the control element 16a beyond the control face 62a. A slot-shaped recess 78a is admitted in an edge region 76a of the control element 16a which defines the recess 58a with respect to the interior which is surrounded by the main handle 40a or by the motor housing 44a. The slot-shaped recess 78a is provided for the purpose of receiving a guide region 82a of the release element 22a. The guide region 82a extends, in this connection, through the slot-shaped recess 78a into the interior which is surrounded by the main handle 40a or by the motor housing 44a. Two fastening elements 84a, 86a of the release element 22a are arranged on the guide region 82a. The fastening elements 84a, 86a are realized integrally with the guide region 82a. The fastening elements 84a, 86a are realized as latching hooks (FIG. 5). However, it is also conceivable for more than two latching hooks to be arranged on the guide region 82a and/or for the fastening elements 84a, 86a to have a different development which appears sensible to an expert.

The latching device 20a has a blocking element 26a for blocking a movement of the control element 16a in dependence on a position of the release element 22a, which is fixed on the release element 22a. The blocking element 26a, in this connection, is fixed on the release element 22a by means of the fastening elements 84a, 86a which are realized as latching hooks. To this end, the latching element 26a has a connecting recess 94a which corresponds with the fastening elements 84a, 86a which are realized as latching hooks. The guide region 82a, with the blocking element 26a mounted on the release element 22a, extends into a recess (not shown here in any detail) of the blocking element 26a which corresponds with the guide region 82a in order to prevent the locking element 26a rotating in relation to the release element 22a. The fastening elements 84a, 86a, which are realized as latching hooks, engage behind the locking element 26a in a mounted state such that the locking element 26a is fixed on the release element 22a along a direction which extends at least substantially parallel to the main extension direction 48a and along a direction which extends at least substantially at right angles to the main extension direction 48a. However, it is also conceivable for the locking element 26a to have more than one recess to form a receiving means of fastening elements 84a, 86a of the release element 22a. The locking element 26a, along the longitudinal direction 34a, has an overall extension which corresponds to more than 70% of an overall extension of the release element 22a along the longitudinal direction 34a.

FIG. 6 shows alternative fastening elements 84a′, 86a′. The alternative fastening elements 84a′, 86a′ are realized as screws which are screwable into threaded bores 90a′, 92a′ of the release element 22a′. The threaded bores 90a′, 92a′ are provided in the guide region 82a′ on a side of the guide region 82a′ which faces the interior which is surrounded by the main handle 40a or the motor housing 44a. In this connection, the locking element 26a′ has two connecting recesses 94a′, 106a′, through which the fastening elements 84a′, 86a′ which are realized as screws engage in a mounted state.

The blocking device 20a also includes a spring element 28a which is provided for the purpose of acting upon the release element 22a with a spring force at least in one direction 32a. The spring element 28a, in this connection, is realized as a compression spring, in particular as a helical compression spring. However, it is also conceivable for the spring element 28a to have a different development which appears sensible to an expert, such as, for example, as a tension spring, a torsion spring, etc. The spring element 28a is arranged in the slot-shaped recess 78a of the control element 16a. One end of the spring element 28a is arranged on a bolt-shaped holding element 96a of the control element 16a. The holding element 96a is realized integrally with the control element 16a. Another end of the spring element 28a is arranged on a bolt-shaped holding element 98a of the guide region 82a of the release element 22a (FIG. 4). Consequently, the spring element 28a is supported by way of one end on the control element 16a and by way of the other end on the release element 22a. The spring element 28a is provided for the purpose of acting upon the release element 22a and the blocking element 26a together with a spring force in the direction of a blocking position of the blocking element 26a.

In the blocking position of the blocking element 26a, the blocking element 26a, by way of a blocking continuation 100a, abuts against a stop face 104a of a stop 102a of the blocking device 20a which is arranged in the interior which is surrounded by the main handle 40a or by the motor housing 44a (FIG. 2). The blocking continuation 100a extends proceeding from the blocking element 26a in a direction which is remote from the release element 22a. The stop face 104a of the stop 102a is arranged on a side of the stop 102a which faces the control element 16a. The stop 102a, along the main extension direction 48a, is at a distance to the switching element 18a which corresponds approximately to an overall extension of the blocking element 26a along the longitudinal direction 34a. By means of the blocking continuation 100a abutting against the stop face 104a of the stop 102a, a movement of the control element 16a in the blocking position of the blocking element 26a is prevented as extensively as possible. Consequently, actuation of the switching element 18a is prevented by the actuating continuation 88a and the right angle grinding tool is stopped from starting up. However, it is also conceivable for the blocking element 26a to have two or several blocking continuations 100a which interact in each case with a stop face 104a of stops 102a in a blocking position of the blocking element 26a in order to prevent a movement of the control element 16a in the blocking position of the blocking element 26a as extensively as possible. In the case of an alternative development of the blocking element 26a (not shown here in any detail), the blocking element has two blocking continuations 100a. In this connection, one of the blocking continuations 100a is arranged on a region of the blocking element 26a which faces the gear housing 42a and one of the blocking continuations 100a is arranged on a region of the blocking element 26a which faces the switching element 18a. The blocking continuations 100a interact in a locking position of the locking element 26a with stop faces 104a of stops 102a which are arranged in the interior which is surrounded by the main handle 40a or the motor housing 44a.

To start up the right angle grinding tool 36a, an operator has to move the release element 22a and the blocking element 26a out of the blocking position of the blocking element 26a. In this connection, an operator moves the release element 22a in a translatory manner in the control element 16a, in particular in a direction which is remote from the gear housing 42a. However, it is also conceivable for the operator to have to move the release element 22a in a different direction which appears sensible to an expert in order to move the blocking element 26a out of the blocking position, such as, for example, in a direction which faces the gear housing 42a. The movement of the release element 22a also moves the blocking element 26a, as a result of the fixing of the locking element 26a by means of the fastening elements 84a, 86a on the release element 22a, in a translatory manner in a direction which is remote from the gear housing 42a. The blocking continuation 100a of the blocking element 26a is consequently moved away from the stop face 104a of the stop 102a. As a result, a possibility of movement of the control element 16a in the direction of the switching element 18a is released. The operator can now start up the right angle grinding tool 36a as a result of an introduction of force onto the control element 16a in the direction of the switching element 16a. In this connection, the switching element 18a is actuated by means of the actuating continuation 88a of the control element 16a, whereupon a circuit to a power supply of the drive unit 50a which is realized as an electric motor is closed. Once the operator has stopped introducing force onto the control element 16a in the direction of the switching element 18a, the control element 16a is moved by means of the spring element (not shown in any detail) in a direction which is remote from the switching element 18a. In this connection, the release element 22a is moved together with the blocking element 26a in the direction of the blocking position of the blocking element 26a by means of a spring force of the spring element 28a which is arranged between the control element 18a and the release element 22a. Consequently, the blocking element 26a passes back into contact with the stop face 104a of the stop 102a which faces the control element 18a and blocks a movement of the control element 16a in the direction of the switching element 18a as extensively as possible.

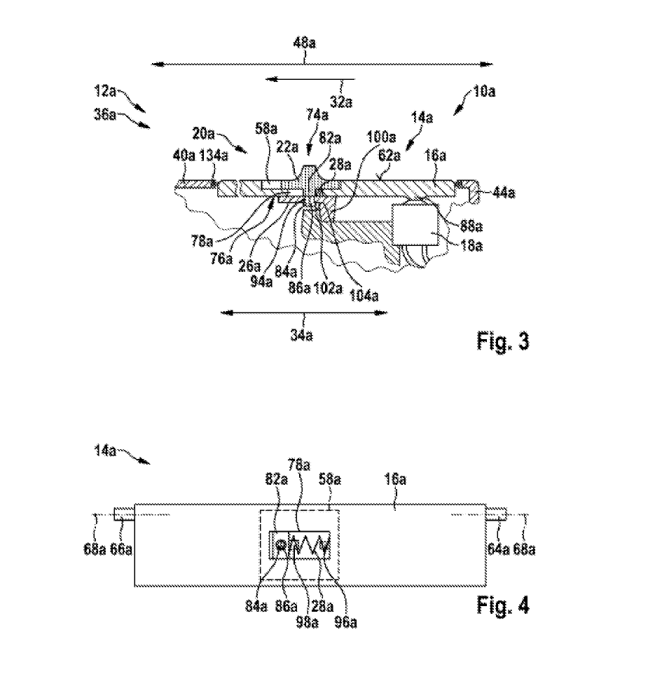

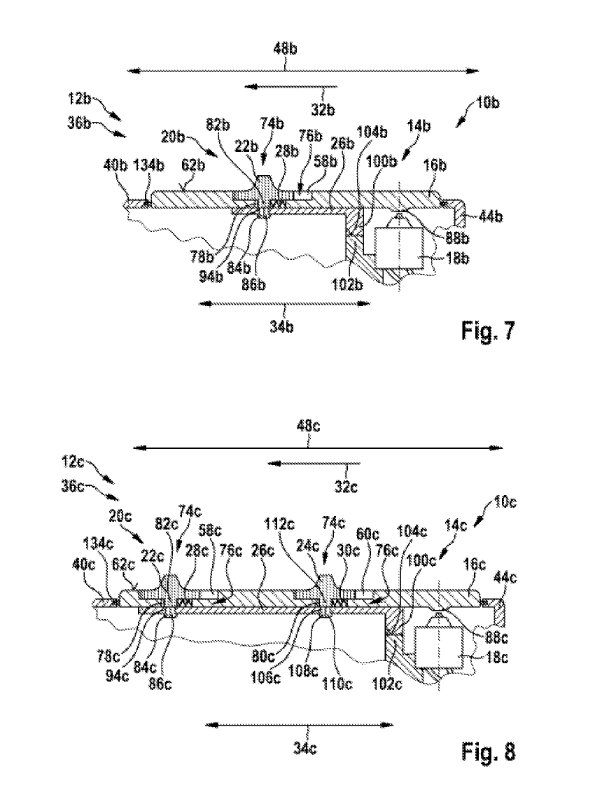

FIGS. 7 to 10 show alternative exemplary embodiments. Components, features and functions which substantially remain the same are in principle numbered with the same references. To differentiate between the exemplary embodiments, the letters a to e are added to the references of the exemplary embodiments. The following description is essentially restricted to the differences to the first exemplary embodiment in FIGS. 1 to 6, it being possible to refer to the description of the first exemplary embodiment with reference to components, features and functions which remain the same.

FIG. 7 shows an alternative machine tool switching device 10b of a portable machine tool 12b. The portable machine tool 12b has a design which is analogous to the portable machine tool 12a described in FIGS. 1 to 6. The machine tool switching device 10b includes a switching unit 14b which has a movably mounted control element 16b for actuating a mechanical, electric and/or electronic switching element 18b, and a blocking device 20b for blocking at least one movement of the control element 16b which has a movably mounted release element 22b which is provided for the purpose of lifting the block of the control element 16b. The release element 22b is mounted so as to moveable in a translatory manner in a recess 58b of the control element 16b. The blocking device 20b has a blocking element 26b for blocking a movement of the control element 16b in dependence on a position of the release element 22b, said blocking element being fixed on the release element 22b. The blocking element 26b, along a longitudinal direction 34b of the control element 16b, has an overall extension which is approximately double the size of an overall extension of the release element 22b along the longitudinal direction 34b. The blocking element 26b, in a blocking position, abuts against a stop face 104b of a stop 102b of the blocking device 20b. The stop 102b is at a distance to the switching element which corresponds to approximately 20% of the overall extension of the release element 22b along the longitudinal direction 34b. Reference may be made essentially to the description of FIGS. 1 to 6 with reference to function, design, and arrangement of the individual elements, components, units and devices.

FIG. 8 shows a further alternative machine tool switching device 10c of a portable machine tool 12c. The portable machine tool 12c has a design which is analogous to the portable machine tool 12a described in FIGS. 1 to 6. The machine tool switching device 10c includes a switching unit 14c which has a movably mounted control element 16c for actuating a mechanical, electric and/or electronic switching element 18c, and a blocking device 20c for blocking at least one movement of the control element 16c which has a movably mounted release element 22b which is provided for the purpose of lifting the block of the control element 16c. In addition, the blocking device 20c has a further release element 24c which is arranged together with the release element 22c on the control element 16c so as to be movable in a translatory manner. The release elements 22c, 24c are mounted so as to moveable in a translatory manner in recesses 58c, 60c of the control element 16c. The recesses 58c, 60c are arranged spaced apart in relation to one another along a longitudinal direction 34c of the control element 16c. The blocking device 20c has a blocking element 26c for blocking a movement of the control element 16c in dependence on a position of the release elements 22c, 24c, said control element being fixed on the release elements 22c, 24c. In this connection, the blocking element 26c has two connecting recesses 94c, 106c in which fastening elements 84c, 86c, 108c, 110c of the release elements 22c, 24c, which are realized as latching hooks, engage and fix the blocking element 26c on the release elements 22c, 24c. In addition, the blocking device 20c has two spring elements 28c, 30c which are provided for the purpose of acting upon the release elements 22c, 24c with a spring force at least in one direction 32c. Reference may be made essentially to the description of FIGS. 1 to 6 with reference to function, design, and arrangement of the individual elements, components, units and devices.

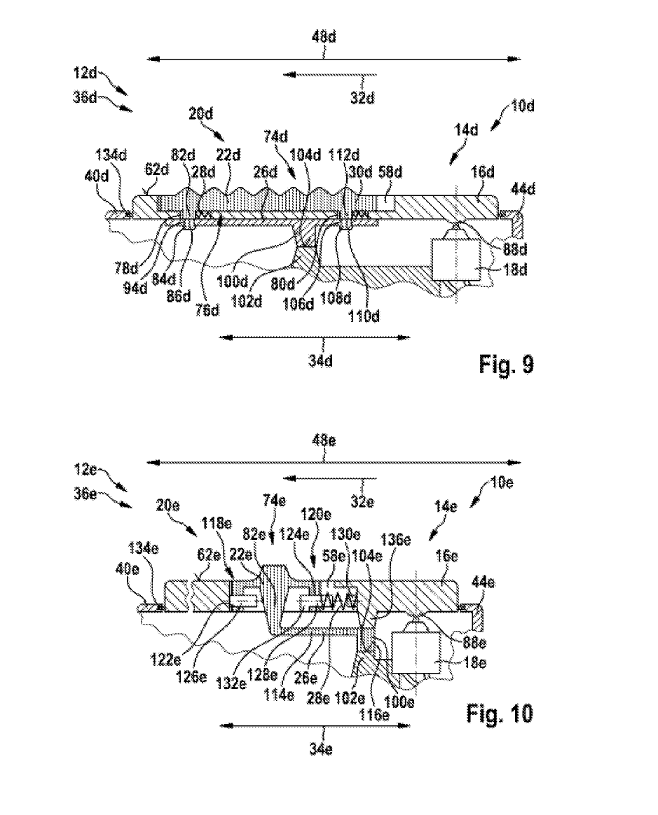

FIG. 9 shows a further alternative machine tool switching device 10d of a portable machine tool 12d. The portable machine tool 12d has a design which is analogous to the portable machine tool 12a described in FIGS. 1 to 6. The machine tool switching device 10d includes a switching unit 14d which has a movably mounted control element 16d for actuating a mechanical, electric and/or electronic switching element 18d, and a blocking device 20d for blocking at least one movement of the control element 16d which has a movably mounted release element 22d which is provided for the purpose of lifting the block of the control element 16d. The release element 22d is mounted so as to movable in a translatory manner in a recess 58d of the control element 16d. The blocking device 20d has a blocking element 26d for blocking a movement of the control element 16d in dependence on a position of the release element 22d, said control element being fixed on the release element 22d. The release element 22d has an extension along a longitudinal direction 34d of the control element 16d which is greater than 20% of an overall extension of the control element 16d along the longitudinal direction 34d. In particular, the release element 22d has an extension along the longitudinal direction 34d which is greater than 40% of an overall extension of the control element 16d along the longitudinal direction 34d.

The release element 22d also has a ribbed surface structure on a side of the release element 22d which is remote from the blocking element 26d in order to achieve a high level of grip for actuation by means of a hand and/or a finger of an operator. In addition, the release element 22d has two guide regions 82d, 112d which are arranged spaced apart in relation to one another along the longitudinal direction 34d. The guide regions 82d, 112d are in each case arranged in a slot-shaped recess 78d, 80d in the control element 16d. The blocking element 26d has two connecting recesses 94d, 106d in which fastening elements 84d, 86d, 108d, 110d of the release element 22d, which are realized as latching hooks, engage for fixing the blocking element 26d on the release element 22d. A blocking continuation 100d of the blocking element 26d, in this connection, is arranged along the longitudinal direction 34d between the connecting recesses 94d, 106d. In addition, the blocking device 20d has two spring elements 28d, 30d which are provided for the purpose of acting upon the release element 22d with a spring force at least in one direction 32d. Reference may be made essentially to the description of FIGS. 1 to 6 with reference to function, design, and arrangement of the individual elements, components, units and devices.

FIG. 10 shows a further alternative machine tool switching device 10e of a portable machine tool 12e. The portable machine tool 12e has a design which is analogous to the portable machine tool 12a described in FIGS. 1 to 6. The machine tool switching device 10e includes a switching unit 14e which has a movably mounted control element 16e for actuating a mechanical, electric and/or electronic switching element 18e, and a blocking device 20e for blocking at least one movement of the control element 16e which has a movably mounted release element 22e which is provided for the purpose of lifting the block of the control element 16e. The release element 22e is mounted so as to moveable in a translatory manner in a recess 58e of the control element 16e. In this connection, the release element 22e has two bearing arrangement regions 118e, 120e in which, in each case, a bearing arrangement recess 122e, 124e of the release element 22e is arranged. The bearing arrangement recesses 122e, 124e are provided for the purpose of interacting with guide bolts 126e, 128e of the control element 16e in a mounted state of the release element 22e. The guide bolts 126e, 128e are arranged in the recess 58e. One of the guide bolts 126e, 128e, in this connection, is integrally molded on an edge region of the control element 16e which defines the recess 58e. Another of the guide bolts 128e is integrally molded on a web-shaped stabilizing element 132e, which extends at least substantially at right angles to a longitudinal direction 34e of the control element 16e. In this connection, the stabilizing element 132e extends transversely inside the recess 58e. In addition, a spring element 28e of the blocking device 20e is arranged by way of one end on the guide bolt 128e which is integrally molded on the stabilizing element 132e and by way of another end on a guide bolt 130e which is integrally molded on a further edge region which defines the recess 58e. The spring element 28e is provided for the purpose of acting upon the release element 22e with a spring force at least in one direction 32e.

The blocking device 20e has a blocking element 26e for blocking a movement of the control element 16e in dependence on a position of the release element 22e, said control element being fixed on the release element 22e. In this connection, the blocking element 26e is realized integrally with the release element 22e. In addition, the blocking element 26e has an L-shaped development. A first leg 114e of the blocking element 26e extends in a mounted state of the release element 22e at least substantially parallel to a longitudinal direction 34e of the control element 16e. A second leg 116e extends at least substantially at right angles to the first leg 114e. The second leg 116e forms a blocking continuation 100e which is provided for the purpose of interacting with a stop 102e of the blocking device 20e for blocking a movement of the control element 16e. In addition, the blocking continuation 100e interacts with a transmission continuation 136e of the control element 16e on a side of the blocking element 26e which is remote from the stop 102e. The transmission continuation 136e is provided for the purpose of transmitting a force onto the blocking continuation 100e when an operator introduces a force onto the control element 16e in a blocking position of the blocking element 26e in order to prevent a movement of the control element 16e in as extensive a manner as possible. The transmission continuation 136e extends proceeding from the control element 16e in the direction of the stop 102e. In this connection, the transmission continuation 136e is realized integrally with the control element 16e. However, it is also conceivable for the transmission continuation 136e to be fixed on the control element 16e by means of a form-fitting and/or by means of a force-fitting connection. Reference may be made essentially to the description of FIGS. 1 to 6 with reference to function, design, and arrangement of the individual elements, components, units and devices.

1. A machine tool switching device, comprising:
at least one switching unit which has having at least one movably mounted control element for actuating configured to actuate one or more of a mechanical switching element, an electric switching element, and an electronic switching element; and
at least one blocking device configured to block at least one movement of the control element, said blocking device having at least one movably mounted release element configured to lift the block of the control element,
wherein the release element is mounted so as to be movable in a translatory manner.

2. The machine tool switching device as claimed in claim 1, wherein the release element is mounted on the control element so as to be movable in a translatory manner.

3. The machine tool switching device as claimed in claim 1, wherein the release element is arranged at least in part in a recess of the control element.

4. The machine tool switching device as claimed in claim 1, wherein the blocking device has at least one blocking element configured to block a movement of the control element in dependence on a position of the release element, said blocking element being fixed on the release element.

5. The machine tool switching device as claimed in claim 4, wherein the blocking element is configured integrally with the release element.

6. The machine tool switching device as claimed in claim 1, wherein the blocking device has at least one spring element configured to act upon the release element with a spring force at least in one direction.

7. The machine tool switching device as claimed in claim 1, wherein the blocking device has at least one further release element arranged together with the release element on the control element so as to be movable in a translatory manner.

8. The machine tool switching device as claimed in claim 1, wherein, along a longitudinal direction of the control element, the release element has an extension which is greater than 20% of an overall extension of the control element along the longitudinal direction.

9. The machine tool switching device as claimed in claim 1, wherein the control element is pivotably mounted.

10. A portable machine tool, comprising:
at least one machine tool switching device including:
at least one switching unit having at least one movably mounted control element configured to actuate one or more of a mechanical switching element, an electric switching element, and an electronic switching element; and
at least one blocking device configured to block at least one movement of the control element, said blocking device having at least one movably mounted release element configured to lift the block of the control element,
wherein the release element is mounted so as to be movable in a translatory manner.

11. The machine tool switching device as claimed in claim 1, wherein the machine tool switching device is configured for portable machine tools.

12. The portable machine tool as claimed in claim 10, wherein the portable machine tool is configured as a right angle grinding tool.
